(19) United States
(12) Patent Application Publication
(10) Pub. No.: US 2007/0195073 A1
(43) Pub. Date: Aug. 23, 2007

(54) Display panel, display apparatus, semiconductor integrated circuit and electronic apparatus

(76) Inventor: Gaku Izumi, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/592,663

(22) PCT Filed: Mar. 16, 2005
(86) PCT No.: PCT/JP05/05308

§ 371 Date: Sep. 13, 2006

(30) Foreign Application Priority Data
Mar. 29, 2004 (JP) 2004-094117

(51) Int. Cl. G09G 5/00

(52) U.S. Cl. 345/204

(57) ABSTRACT

A display panel which achieves a high display quality is implemented. A drive circuit which drives a display panel which has a display region wherein sub pixels as minimum display units are arranged in a matrix includes a group of digital/analog conversion circuits configured to convert signal line data corresponding to the sub pixels individually into analog values. The drive circuit further includes wiring line patterns configured to apply gradation reference voltages to the group of digital/analog conversion circuits for individually corresponding colors. The drive circuit further includes sample hold circuits configured to sample hold the gradation reference voltages corresponding to the individual colors within a period of time within a non-light emitting period of the display region and apply the gradation reference voltages to the corresponding wiring line patterns within a light emitting period of the display region.

### TECHNICAL FIELD

This invention relates to a display panel which has a display region wherein sub pixels as minimum display units are arrayed in a matrix. The present invention further relates to a semiconductor integrated circuit which has a built-in drive circuit for driving a display panel. The present invention relates more specifically to a display apparatus wherein a display panel and a drive circuit for the display panel are incorporated in the same housing. The present invention relates also to an electronic apparatus which incorporates a display panel or a drive circuit for a display panel.

### BACKGROUND ART

Display apparatus wherein an image is displayed by means of sub pixels disposed in a matrix include a flat panel display. The flat panel display is a display apparatus which includes a housing having a shape of a plate and has a flat screen. The flat panel display has a volume smaller than that of display apparatus of the CRT (Cathode Ray Tube) type. Therefore, the flat panel display has been popularized widely in recent years.

Such flat panel displays are divided into two types including a self-luminous type and a non-self-luminous type. Self-luminous type flat panel displays include, for example, an EL (Electro Luminescence) display, an LED (Light Emitting Diode) display, a PDP (Plasma Display Panel) display, and an FED (Field Emission Display). Non-self-luminous type flat panel displays include, for example, a liquid crystal display.

In any display, turning on/off of each sub pixel is implemented by driving of an active element. It is to be noted that a drive signal to the active element is supplied through a signal line. A plurality of active elements are disposed on the signal line, and a drive signal is supplied only to one of the active elements which is selected through a scanning line.

One drive circuit is provided for one signal line. One drive circuit is formed, for example, from a sample/hold circuit and a digital/analog conversion circuit. Usually, drive circuits of the type are formed as peripheral circuits of a display panel (refer to the official gazette of Japanese Patent Laid-open No. 2003-108033 and the official gazette of Japanese Patent Laid-open No. 2003-228341).

Incidentally, the display characteristic of a display is influenced by aged deterioration, a temperature variation and so forth. Reduction of such influence is necessary in order to maintain a high display quality. One of adjustment items is a gradation reference voltage of the D/A conversion circuits. Conventionally, adjustment of the gradation reference voltage is performed uniformly for all D/A conversion circuits which form the drive circuits.

However, the influence which a physical luminance variation has on the display performance is not necessarily uniform. In other words, even if the luminance variation is physically same, the variation perceived with the naked eye is not uniform. Further, although the characteristic deterioration of a self-luminous element proceeds in proportion to the accumulated emitted light amount, the accumulated emitted light amounts for individual colors are not necessarily equal to each other.

### DISCLOSURE OF THE INVENTION

An aspect of the present invention adopts a configuration wherein the gradation reference voltage of D/A conversion circuits can be adjusted for individual colors. Another aspect of the present invention adopts a circuit configuration wherein a gradation reference voltage is sample held within a non-light emitting period and is supplied to a D/A conversion circuit within a light emitting period.

### BRIEF DESCRIPTION OF THE DRAWINGS

FIG. 1 is a view showing an example of a configuration of a display panel;

FIG. 2 is a view showing another example of a configuration of a display panel;

FIG. 3 is a view showing an example of a configuration of a drive circuit;

FIG. 4 is a view showing an example of a basic configuration of a D/A conversion circuit;

FIG. 5 is a view illustrating a relationship between a maximum reference voltage to be supplied to the D/A circuit and an output voltage;

FIG. 6 is a view illustrating an input/output characteristic of the D/A conversion circuit;

FIG. 7 is a view showing an embodiment of a sample hold circuit;

FIG. 8 is a view illustrating a relationship between a light emitting period and a non-light emitting period of an image signal;

FIG. 9 is a view showing another example of a configuration of the drive circuit;

FIG. 10 is a view illustrating a relationship between an intermediate reference voltage to be supplied to the D/A circuit and an output voltage;

FIG. 11 is a view illustrating an input/output characteristic of the D/A conversion circuit;

FIG. 12 is a view showing a further example of a configuration of the drive circuit;

FIG. 13 is a view showing a still further example of a configuration of the drive circuit;

FIG. 14 is a view showing a yet further example of a configuration of the drive circuit;

FIG. 15 is a view showing a yet further example of a configuration of the drive circuit;

FIG. 16 is a view illustrating a relationship between the brightness and the light emitting period which depends upon a difference in driving conditions;

FIG. 17 is a view illustrating a relationship between the light emission luminance and the life;

FIG. 18 is a view showing a yet further example of a configuration of the drive circuit;

FIGS. 19A and 19B are views illustrating examples of a scanning line selection pulse corresponding to two different light emitting periods;

FIG. 20 is a view showing an embodiment of a display object decision circuit; and

FIG. 21 is a view showing an example of a configuration of an electronic apparatus.

### BEST MODE FOR CARRYING OUT THE INVENTION

In the following, embodiments of different aspects of the present invention are described. It is not be noted that, to a configuration which is not particularly shown in the drawings or described in the specification, a well-known or publicly known technique of the pertaining technical field is applied. Further, the embodiments described below are mere embodiments of the present invention, and the present invention is not limited to such embodiments.

### (1) EXAMPLE OF A CONFIGURATION OF THE DISPLAY PANEL

First, an example of a configuration of a display panel incorporated in a display apparatus is described. It is to be noted that the display apparatus may be, for example, an EL display (organic or inorganic), an LED display, a PDP display, an FED display or the like.

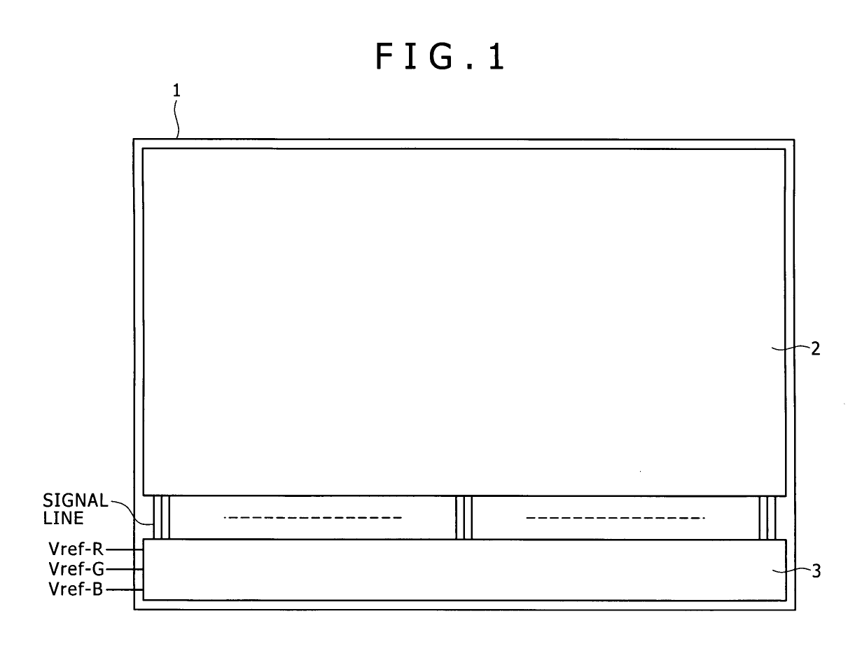

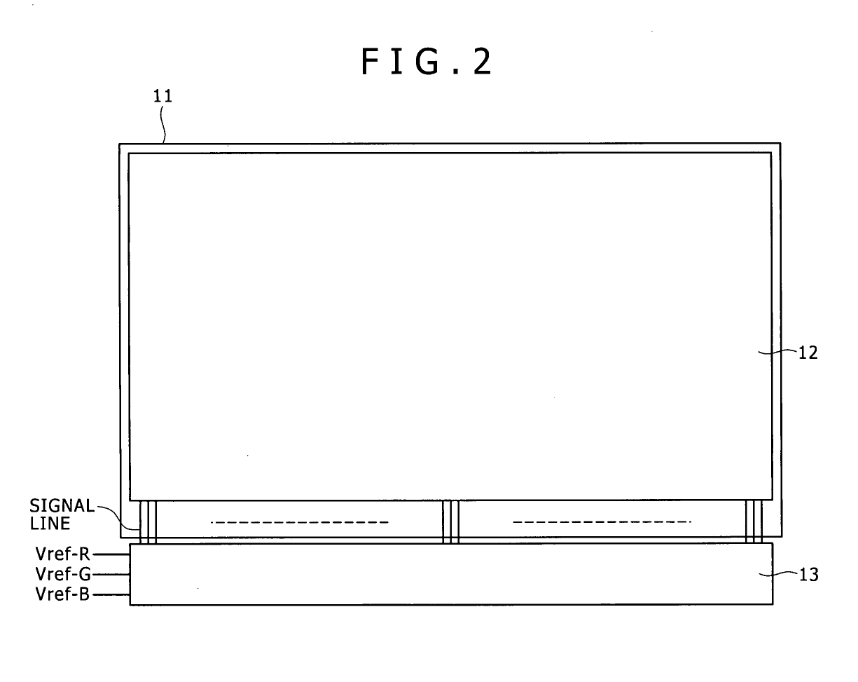

Display panels can be classified into those wherein a drive circuit is formed on a panel substrate and those wherein a drive circuit is formed on a substrate different from a panel substrate. An example of the former configuration is shown in FIG. 1 and an example of the latter configuration is shown in FIG. 2. It is to be noted that typically a glass substrate or a plastic substrate is used for the panel substrate.

The display panel 1 shown in FIG. 1 includes a display region 2 and a drive circuit region 3 formed integrally with the display region 2. Meanwhile, the display panel 11 shown in FIG. 2 includes a display region 12, and a drive circuit section 13 is formed separately from the display panel 11. For example, the drive circuit section 13 is formed on a semiconductor substrate.

The display panel shown in FIG. 1 and the display panel shown in FIG. 2 have a basically same configuration while they are different only in a method of formation of the drive circuit. For example, in the display region, sub pixels as minimum display units are arranged in a matrix. Each sub pixel corresponds to one of colors which form one picture element (pixel). In other words, one pixel corresponds to three sub pixels of R (red), G (green) and B (blue).

An active element is coordinated with each sub pixel. Drive circuits drive such active elements. The drive circuits include a vertical drive circuit and a horizontal drive circuit. The vertical drive circuit is used to select one of a plurality of scanning lines. Meanwhile, the horizontal drive circuit is used to apply a drive signal to signal lines.

### (2) EXAMPLES OF THE DRIVE CIRCUITS

In the following, an embodiment of a drive circuit principally as the horizontal drive circuit is described. It is to be noted that, unless otherwise specified, a well-known circuit configuration is applied to the vertical drive circuit.

### (a) Configuration Example 1

(a-1) Circuit Configuration

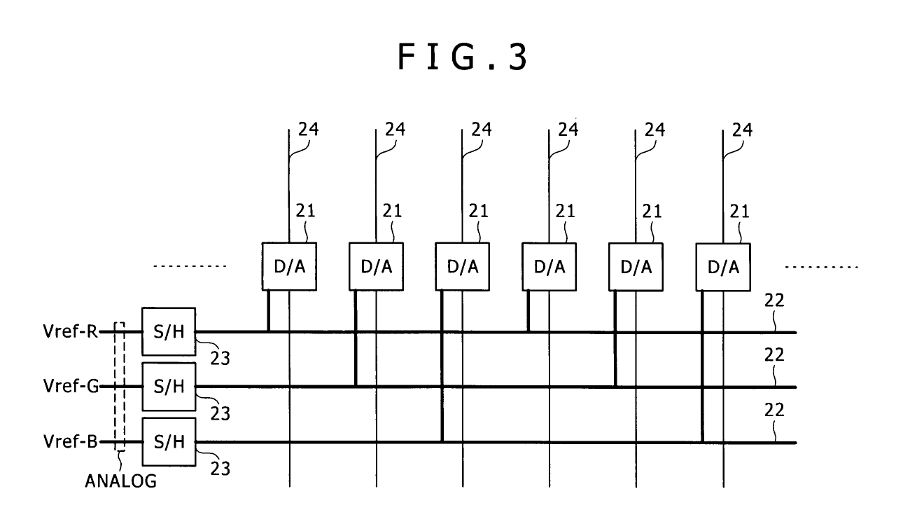

FIG. 3 shows an example of a configuration of the horizontal drive circuit. This horizontal drive circuit includes D/A conversion circuits 21, wiring line patterns 22 for gradation reference voltages, and sample hold circuits 23 each for outputting a gradation reference voltage as principal components.

The number of D/A conversion circuits 21 provided is equal to the number of signal lines 24. In particular, a number of D/A conversion circuits 21 equal to the horizontal sub pixel number of the display region are disposed. Each D/A conversion circuit 21 generates a drive voltage (analog) according to signal line data (digital) and applies the drive voltage to the corresponding signal line 24. As a result, a luminance according to the drive voltage appears at a sub pixel at an intersecting portion between a scanning line selected by the vertical drive circuit and the signal line.

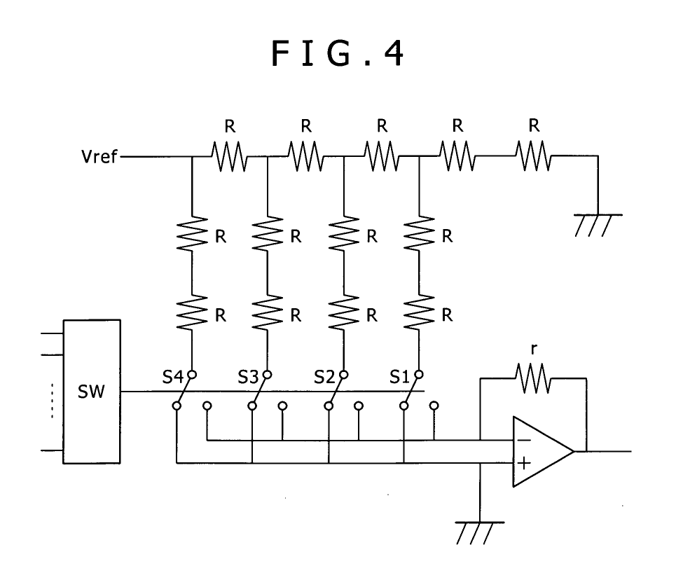

FIG. 4 shows an example of a configuration of the D/A conversion circuit 21. FIG. 4 represents a D/A conversion circuit of the ladder resistance type called 2R-R type. This represents that the branching destinations have a resistance value of 2R (2×R) and the resistance value of the entire D/A conversion circuit is R.

In the case of the present configuration, the magnitude of current to flow decreases to ½ every time a branch appears successively in order from a branching point of the reference power supply (maximum reference voltage) side. The current after branching flows into an input terminal of one of switches S1 to S4 (in the case of 4 bits). It is to be noted that the reference power supply Vref corresponds to one of gradation reference voltages Vref-R, Vref-G and Vref-B.

Each switch is controlled to on/off in response to signal line data. Each switch provides current flowing thereto when it is on to the operational amplifier side but provides current flowing therethrough when it is off to the ground side. As a result, current (current sum from the switches) corresponding to a digital value flows into an output resistor r of the operational amplifier. A voltage appearing across the output resistor r at this time is an output voltage.

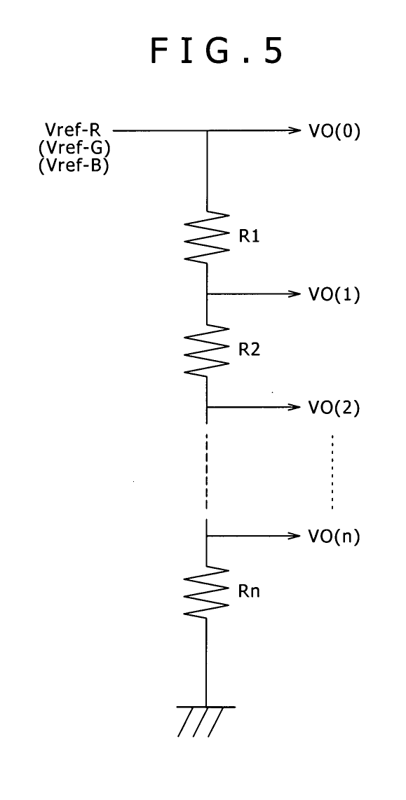

FIG. 5 shows an example of a functional configuration of the D/A conversion circuit 21. As shown in FIG. 5, the D/A conversion circuit 21 functions such that it selectively outputs one of divided voltage outputs which appear at nodes of ladder resistors R1, R2, . . . , Rn connected in series. In other words, the D/A conversion circuit 21 functions such that it outputs a divided voltage output from one of the junctions which is selected with image data (signal line data).

Incidentally, the reference power supply is the maximum reference voltage VO(0). Meanwhile, intermediate reference voltages VO(1) to VO(n) obtained by dividing the reference power supply are given by the number of ladder resistors and the resistance ratio. It is to be noted that the voltage across each resistor (for example, the voltage difference between VO(0) and VO(1)) is divided at a fixed ratio. This is because it is intended to prevent the necessity for a number of resistances equal to the number of necessary gradations. As a result, simplification of the circuit is anticipated.

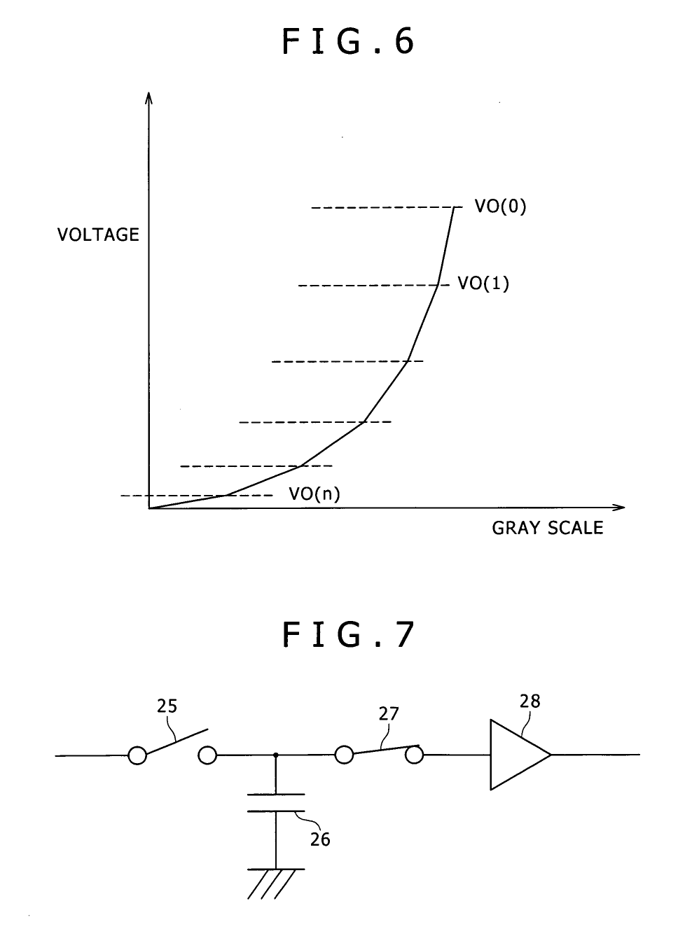

FIG. 6 illustrates a relationship between the gradation voltages VO(0), VO(1) to VO(n) and corresponding inputs/outputs. The smoothness of the gamma curve is adjusted by the resistance division number and the ratio between the resistance values. Also optimization of the gamma curve according to a device characteristic is adjusted with the resistance division number and the ratio between the resistance values.

It is to be noted that the intermediate reference voltages VO(1) to VO(n) of the individual colors vary in an interlocking relationship with the adjustment (increase or decrease) of the gradation reference voltages Vref-R, Vref-G and Vref-B corresponding to the colors. In other words, the gamma curve shown in FIG. 6 is deformed in an upward or downward direction. As a result, outputting of a drive voltage (analog) for a necessary gradation number can be obtained while the resolution is maintained.

Such adjustment for the individual colors is implemented by the wiring line patterns 22 (22R, 22G, 22B) connected for the individual colors to the D/A conversion circuits 21. For example, to the D/A conversion circuit 21 corresponding to R (red), the wiring line pattern 22R corresponding to the reference power supply Vref-R is connected.

Similarly, the wiring line pattern 22G corresponding to the gradation reference voltage Vref-G is connected to the D/A conversion circuit 21 corresponding to G (green). Similarly, the wiring line pattern 22B corresponding to the gradation reference voltage Vref-B is connected to the D/A conversion circuit 21 corresponding to B (blue).

The three wiring line patterns are independent of one another, and a gradation reference voltage can be applied to each of the three wiring line patterns independently of the other two wiring line patterns. For example, only the gradation reference voltage for the D/A conversion circuit which generates the sub pixel group corresponding to the R (red) color can be raised or dropped independently.

As described hereinabove, if the gradation reference voltage is raised or lowered, then also the drive voltage (analog) to be outputted can be raised or lowered. It is to be noted that a load capacitor having a sufficiently high capacitance is used for a load capacitor 26.

The sample hold circuits 23 apply gradation reference voltages corresponding to the individual colors to the three wiring line patterns. FIG. 7 shows an example of a circuit of the sample hold circuits 23. It is to be noted that one sample hold circuit is provided for each color.

The sample hold circuit 23 is formed from an input side switch 25, a load capacitor 26, an output side switch 27 and a buffer circuit 28. Here, the sample hold circuit 23 charges the load capacitor 26 with charge when the input side switch 25 is in a closed state and besides the output side switch 27 is in an open state. In other words, a gradation reference voltage is held by the load capacitor 26.

On the other hand, when the input side switch 25 is in an open state and besides the output side switch 27 is in a closed state, the sample hold circuit 23 applies the gradation reference voltage held by the load capacitor 26 to a wiring line pattern 22 through the buffer circuit 28. Typically, a voltage follower circuit is used for the buffer circuit 28.

The sample hold circuit 23 sample holds the gradation reference voltage (analog) within a non-light emitting period and applies the gradation reference voltage within a light emitting period. Accordingly, within a non-light emitting period, the input side switch 25 is controlled to the closed state and the output side switch 27 is controlled to the open state. On the other hand, within a light emitting period, the input side switch 25 is controlled to the open state and the output side switch 27 is controlled to the closed state.

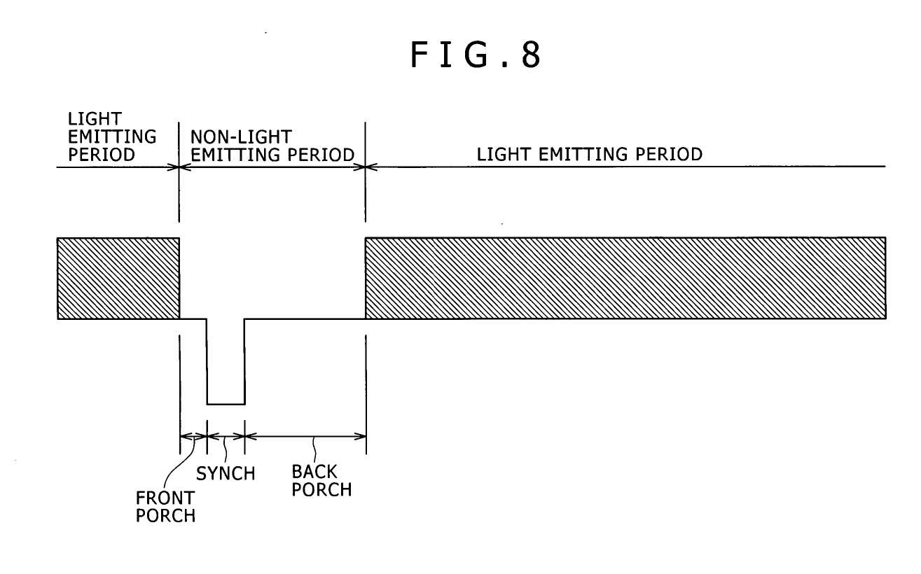

The non-light emitting period signifies a period within which signal line data is not superposed on the image signal. FIG. 8 shows the waveform of the image signal. A portion indicated by slanting lines in FIG. 8 is a light emitting period within which an image signal exists.

Meanwhile, front porch, back porch and synch portions including a vertical synchronizing signal are non-light emitting periods. It is to be noted that the scanning method of the image signal may be any of the line sequential method and the interlaced method.

For example, according to the XBA (eXtended Graphics Array) standards of the VESA (Video Electronics Standards Association), 38 lines from among 806 horizontal scanning lines make non-light emitting periods while the remaining 768 lines make light emitting periods. A circuit which can complete setting of a gradation reference voltage within each such non-light emitting period and can stably supply the gradation reference voltage within each light emitting period is used for the sample hold circuits 23.

(a-2) Displaying Action

Now, a displaying action of a display apparatus which includes a horizontal drive circuit having such a circuit configuration as described above is described. First, an image signal (signal line data) corresponding to each pixel (sub pixel) is inputted to each D/A conversion circuit 21. Naturally, the gradation reference voltage of the D/A conversion circuit 21 is already set to the corresponding sample hold circuit 23.

The image data (signal line data) is converted into an analog value by the corresponding D/A conversion circuit 21 and applied to the corresponding signal line 24. The potential of the signal line 24 is supplied to a light emitting substance or a light emitting element through an active element which is controlled to an active state by the vertical drive circuit.

Thus, a luminance, gradation representation according to the image signal can be achieved. It is to be noted that the hue depends upon the luminances and gradations of the three primary colors (RGB) which form one pixel. Such control is performed for the overall display region. Thus, an image is displayed on the display region.

(a-3) Effects Achieved by the Configuration Example 1

By the adoption of the horizontal drive circuit according to the configuration example 1, the light emission characteristic of the sub pixels can be adjusted for each color. Consequently, the hue and the luminance balance can be adjusted to an optimum state in accordance with the characteristic of the light emitting color material. In other words, further enhancement and optimization of the display quality can be implemented.

Further, the adjustment function for each color can be utilized also for adjustment of the variation of the light emission characteristic caused by aged deterioration (material life and so forth) and the temperature variation. For example, a variation of a characteristic which is known in advance may be stored into an external system and reflected on the maximum reference voltage to be provided by the external system.

It is to be noted that also a measurement result measured on the real time basis can be reflected on the adjustment of the gradation reference voltages. By feeding back an actual measurement value on the real time basis, the display state can be normally maintained to a good state.

Further, the D/A conversion characteristic can be stabilized by supplying a gradation reference voltage set within a non-light emitting period from the sample hold circuit 23 to the D/A conversion circuit 21. It is to be noted that, in a case wherein a gradation reference voltage is normally fed also within a light emitting period, there is the possibility that the gradation reference voltage may be varied by superposition of noise, and there is the possibility that the D/A conversion characteristic may be rendered unstable.

### (b) Configuration Example 2

(b-1) Circuit Configuration

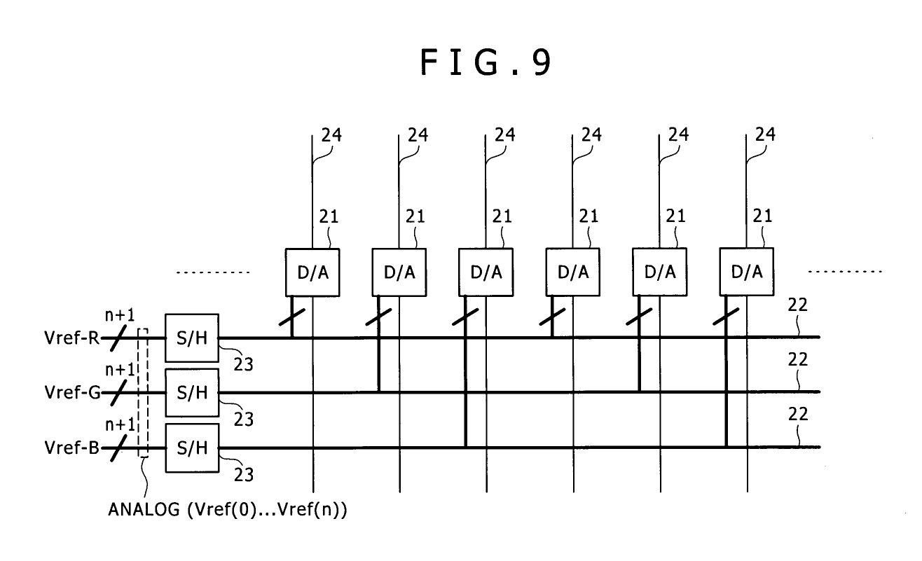

FIG. 9 shows another configuration example of the horizontal drive circuit. The horizontal drive circuit has a basic configuration same as that of the horizontal drive circuit according to the configuration example 1. In the present embodiment, a circuit configuration example wherein the conversion characteristic of the D/A conversion circuits 21 can be set more finely is described.

In particular, a circuit configuration wherein not only a maximum reference voltage but also intermediate reference voltages as gradation reference voltages can be adjusted individually is described. This circuit configuration is effective typically where the gamma curve exhibits different shapes among different colors or where a linear input/output characteristic may be used.

A configuration unique to the present embodiment is that a plurality of gradation reference voltages are applied to each D/A conversion circuit 21. Therefore, the number of necessary sample hold circuits 23 is equal to three times the number of gradation reference voltages set for each one color. Also the number of necessary wiring line patterns 22 is equal.

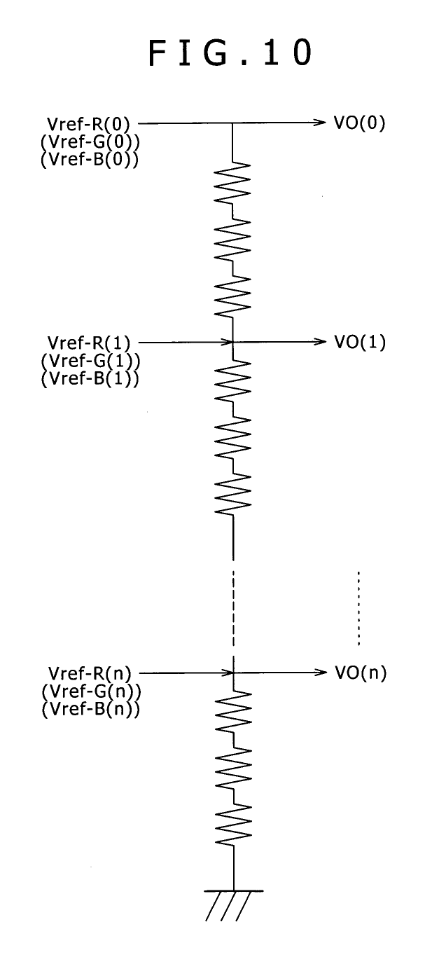

FIG. 10 shows a conceptive configuration of each D/A conversion circuit 21 where n+1 gradation reference voltages are set for one color. In the case of the present embodiment, a plurality of gradation reference voltages generated by an external system are applied to a plurality of nodes of ladder voltage dividing resistors. Consequently, the voltage between adjacent nodes to which the reference voltages are applied can be controlled freely.

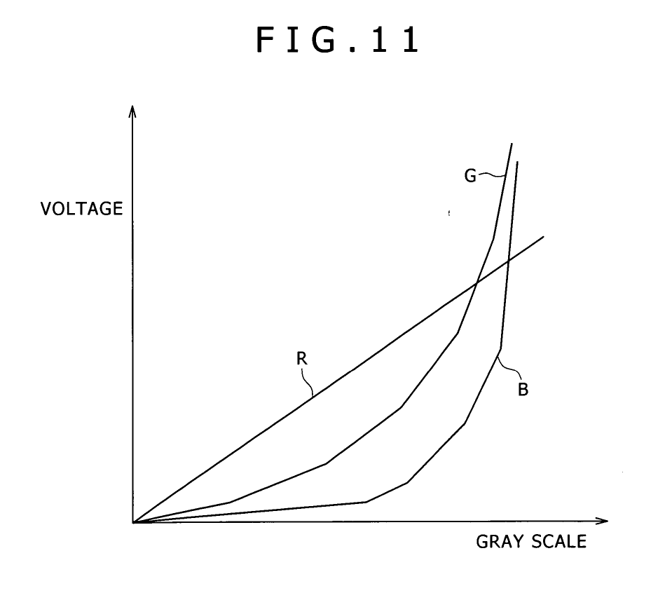

As a result, gamma curves unique to the individual colors can be set as seen in FIG. 11.

For example, the input/output characteristic for R (red) can be made a linear input/output characteristic. Meanwhile, for example, the input/output characteristic for G (green) can be made an input/output characteristic of a higher output power than that for B (blue). Further, also it is possible to provide input/output characteristics different from each other depending upon the gradation level (horizontal axis in FIG. 11) like input/output characteristics for G (green) and B (blue). In the case of FIG. 11, the input/output characteristics for G (green) and B (blue) exhibit an emphasized luminance variation at a high luminance portion thereof but conversely exhibit a contracted luminance variation at a medium luminance portion thereof.

(b-2) Effects Achieved by the Configuration Example 2

In the case of the configuration example 2, the following effects can be implemented in addition to the effects of the configuration example 1. First, more detailed adjustment in color and luminance than that by the configuration example 1 can be implemented. Further, also against aged deterioration or an environmental variation, more detailed adjustment than that by the configuration example 1 can be performed.

Further, the configuration example 2 can implement a conversion characteristic optimum in response to the luminance level. Therefore, an optimum display characteristic can be provided to the display substance. For example, upon display of a text, gradation voltages for attaching importance to the contrast can be generated. Further, for example, upon display of a movie, gradation voltages for attaching importance to the expressional capacity of intermediate gradations can be generated.

Incidentally, attaching importance to the expressional capacity of intermediate gradations signifies to increase the variation (light amount variation) of the output voltage with respect to the variation of the luminance level (image data) in an intermediate luminance region. For such a function as just described above, typically a reference voltage group to be generated by an external system should be changed over in response to the display substance or the like.

For example, a plurality of sets of gradation voltage generation circuits corresponding to individual reference voltage groups may be prepared such that an output of a corresponding one of the gradation voltage generation circuits is selected in accordance with a display mode. The changeover of the display mode is implemented by an operation instruction by a user or an automatic discrimination function.

Or, gradation reference voltage groups corresponding to individual display modes may be stored in a memory such that a selected or automatically discriminated one of the reference voltage groups is generated by one of the gradation voltage generation circuits.

### (c) Configuration Example 3

(c-1) Circuit Configuration

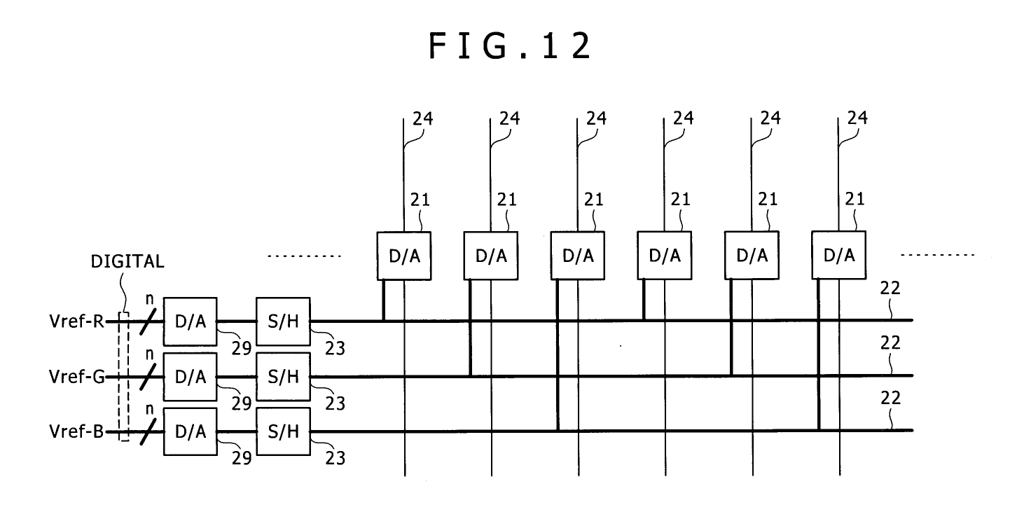

FIG. 12 shows a further configuration example of the horizontal drive circuit. This horizontal drive circuit has a configuration suitable where a gradation reference voltage is inputted digitally. In other words, the horizontal circuit has a configuration suitable where digital data which provides a gradation reference voltage is supplied from an external system.

Accordingly, the horizontal drive circuit has a configuration similar to those of the configuration examples 1 and 2 described hereinabove except that D/A conversion circuits 29 for generation of gradation reference voltages are disposed. However, also it is possible to dispose the D/A conversion circuits 29 in a circuit different from the horizontal drive circuit.

In this instance, the external system and the horizontal drive circuit (D/A conversion circuits 29) are connected to each other by digital signal lines having a width of several bits per one color. In particular, where the bit width per one color is represented by n, the external system and the horizontal drive circuit (D/A conversion circuits 29) are connected to each other by 3×n digital signal lines.

(c-2) Effects Obtained by the Configuration Example 3

In the case of the present configuration example 3, the wiring line length from the generation sources of the gradation reference voltages (D/A conversion circuits 29) to the sample hold circuits 23 can be reduced. Consequently, the influence of noise can be reduced.

Further, since the connection to the external system is digitalized, also the influence of external noise when gradation reference voltages are written into the sample hold circuits 23 can be reduced.

In the case of the present circuit configuration, the external system for providing the gradation reference voltage values need not handle a plurality of different analog voltages. As a result, it is only necessary for the external system to handle a plurality of different analog voltages. In this manner, simplification of the external system can be implemented.

### (d) Configuration Example 4

(d-1) Circuit Configuration

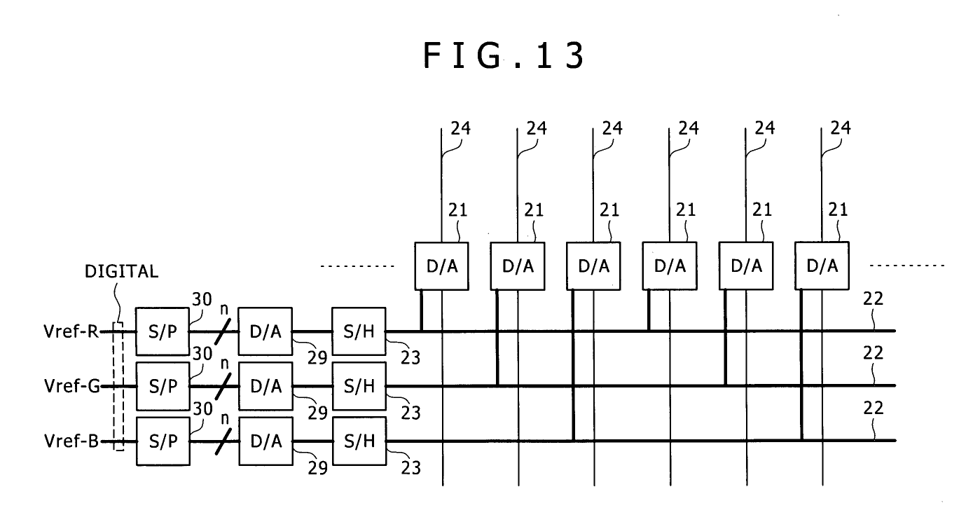

FIG. 13 shows a still further configuration example of the horizontal drive circuit. This horizontal drive circuit is suitable where digital data which provide gradation reference voltages are inputted in the serial form. It is to be noted that the horizontal drive circuit has a basic configuration same as that of the horizontal drive circuit according to the configuration example 3.

The horizontal drive circuit has a unique configuration which is serial/parallel conversion circuits 30 disposed at the stage preceding to the D/A conversion circuits 29 for generation of the gradation reference voltages. The serial/parallel conversion circuits 30 are disposed in a one-by-one corresponding relationship to the individual colors.

Each of the serial/parallel conversion circuits 30 converts digital data inputted in the serial form from the external system into digital data of the parallel form and outputs the resulting digital data to the corresponding sample hold circuits 23. The configuration of the latter is same as that in the configuration example 3, and therefore, description of the same is omitted.

(d-2) Effects Obtained by the Configuration Example 4

In the case of the configuration example 4, by disposing the serial/parallel conversion circuits 30, the number of wiring lines between the external system and the horizontal drive circuit (D/A conversion circuits 29) can be reduced remarkably. In particular, while the necessary number of wiring lines in the configuration example 3 is 3×n (3 colors×n bits), the number of wiring liens in the configuration example 4 can be reduced to three.

Also it is possible to reduce the area required for the wiring line patterns. Particularly where the horizontal drive circuit is incorporated in a semiconductor integrated circuit, the number of pins can be reduced remarkably. Therefore, miniaturization of the package can be implemented. Also further reduction of the mounting area can be anticipated as much. Naturally, the possibility that the gradation reference voltage may be fluctuated by an influence of noise can be reduced similarly as in the configuration example 3.

### (e) Configuration Example 5

(e-1) Circuit Configuration

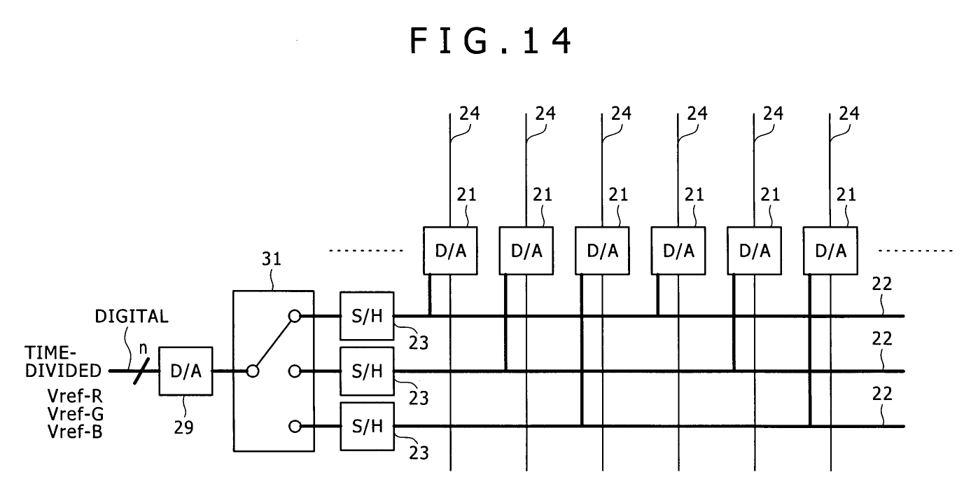

FIG. 14 shows a yet further configuration example of the horizontal drive circuit. This horizontal drive circuit has a configuration suitable where gradation reference voltages for different colors time-division multiplexed with each other are inputted from an external system. It is to be noted that the gradation reference voltages are given as digital data of the parallel type.

This horizontal drive circuit includes, in order from the input side, a D/A conversion circuit 29 for gradation reference voltage generation, a reference voltage switch circuit 31, and sample hold circuits 23 as principal components thereof. It is to be noted that those circuits which are common to those in the embodiments described hereinabove are denoted by like reference numerals.

In the present example, the D/A conversion circuit 29 converts digital data corresponding to individual colors inputted in a time-division multiplexed state thereto into analog values corresponding to gradation reference voltages. In the case of the present example, the D/A conversion circuit 29 executes the digital/analog conversion action within a writing period into the sample hold circuits 23. In other words, the digital/analog conversion action is executed within a non-light emitting period.

It is to be noted that the gradation reference voltage data corresponding to the individual colors may be time division multiplexed in any order. Basically, gradation reference voltage data for the three primary colors are inputted for each one screen (one frame or one field).

However, if the sample hold circuits 23 hold the gradation reference voltages over a plurality of screens, then it is possible to input a digital/analog conversion action at a ratio of once per a plurality of screens. Also it is possible to perform a digital/analog conversion action only for gradation reference voltage data for one color or two colors per one screen.

The reference voltage switch circuit 31 is used to output a gradation reference voltage (analog value) after the digital/analog conversion to the corresponding sample hold circuit 23. This selective outputting is executed in accordance with the time division multiplex order. It is to be noted that the configuration of any other portion of the sample hold circuit 23 is same as that in the configuration example 1, and therefore, description thereof is omitted herein.

(e-2) Effects Obtained by the Configuration Example 5

In the case of the configuration example 5, reduction of the number of wiring lines between an external system and the horizontal drive circuit (D/A conversion circuit 29) can be implemented. In particular, while the necessary number of wiring lines in the configuration example 3 is 3×n (3 colors×n bits), the necessary number of wiring lines in the configuration example 5 can be reduced to n.

Therefore, the area required for the wiring line patterns can be reduced. Particularly where the horizontal drive circuit is incorporated in a semiconductor integrated circuit, the number of pins can be reduced to one third, and therefore, miniaturization of the package can be implemented. Also further reduction of the mounting area can be anticipated as much. Naturally, the possibility that the gradation reference voltage may be fluctuated by an influence of noise can be reduced similarly as in the configuration example 3.

Further, since necessary setting of gradation reference voltages for the sample hold circuits 23 (sample hold action) can be reduced to once for one screen, also where gradation reference voltage data are inputted time-divisionally, a sufficient period of time for stabilization of the gradation reference voltages set to the sample hold circuits 23 can be provided. In other words, even where the display area is increased to form a large screen, the gradation reference voltages can be supplied stably to the D/A conversion circuits 21.

### (f) Configuration Example 6

(f-1) Circuit Configuration

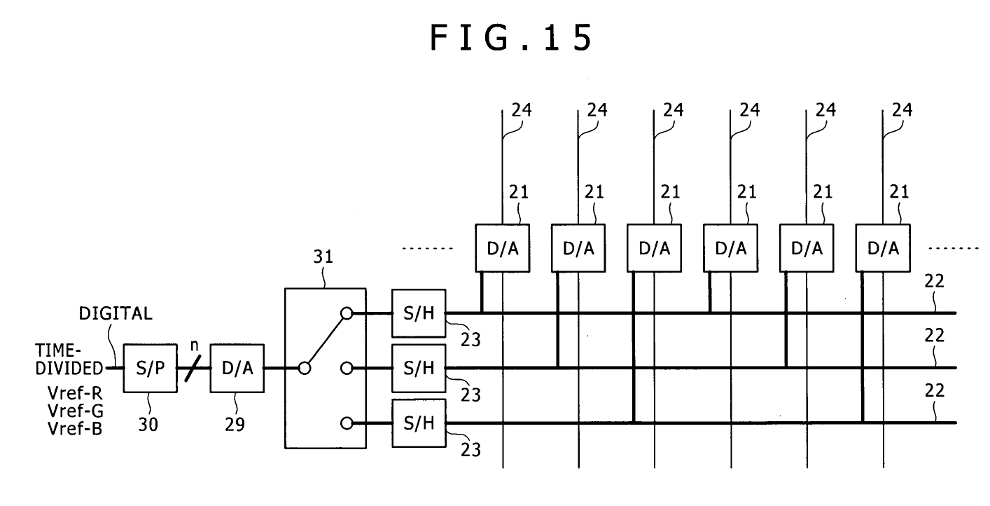

FIG. 15 shows a yet further configuration example of the horizontal drive circuit. This horizontal drive circuit is suitable where inputting of gradation reference voltage data in the configuration example 5 is performed in the serial form. In particular, in the case of the present configuration example, gradation reference voltage data of the serial form are inputted in a time-division multiplexed form.

Therefore, in the present horizontal drive circuit, an S/P conversion circuits 30 is disposed on the input side of the configuration example 5 such that digital data inputted in the serial form are converted into and outputted as data of the parallel form. Naturally, at the point of time at which the data are outputted from the S/P conversion circuit 30, the gradation reference voltages of the parallel form remain in a time-division multiplexed form. Accordingly, the configuration of a succeeding stage is quite same as that in the configuration example 5, and therefore, description thereof is omitted herein.

(f-2) Effects Obtained by the Configuration Example 6

In the present case of the configuration example 6, since the S/P conversion circuit 30 is disposed at the preceding stage to the configuration example 5, further reduction of the number of wiring lines between the external system and the horizontal drive circuit (D/A conversion circuit 29) can be anticipated. In particular, while the necessary number of wiring lines in the configuration example 5 is equal to the number of wiring lines corresponding to the bit width of the parallel data, the necessary number of wiring lines in the configuration example 6 can be reduced to one.

Therefore, the area required for the wiring line patterns can be further reduced. Further, also where the horizontal drive circuit is incorporated in a semiconductor integrated circuit, the necessary number of pins for gradation reference voltages can be reduced to one, and therefore, miniaturization of the package can be anticipated. Also further reduction of the mounting area can be reduced as much.

### (g) Configuration Example 7

(g-1) Circuit Configuration

Here, a drive circuit which has a function of controlling the light emission state of a display region in response to a display object is described. In particular, a drive circuit which can change over gradation reference voltages and a unit light emitting period (given by the width of a scanning pulse) at a time in response to a display object is described.

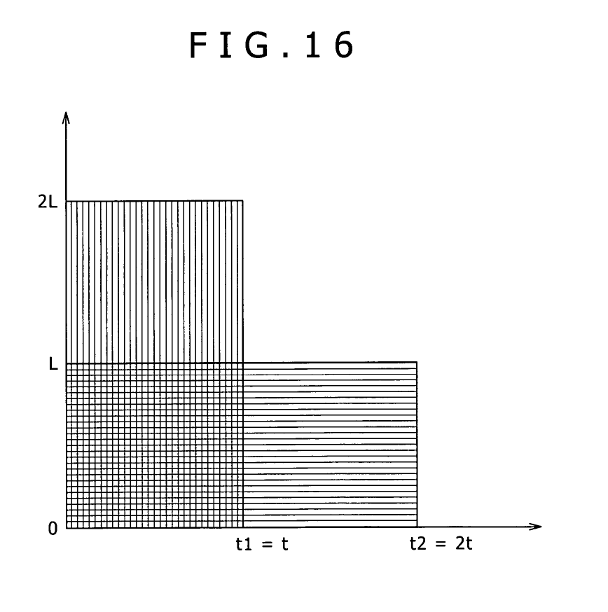

In the present configuration example, attention is paid to a relationship between the visual sense characteristic of the human being and the display performance of a display device. First, the visual sense characteristic of the human being is illustrated in FIG. 16. FIG. 16 illustrated a relationship between the brightness and the light emitting period within a unit time period (CFF: Critical Fusion Frequency) within which the human being does not feel any flickering (flicker). The brightness at a vertical line portion is 2L*t, and the brightness at a horizontal line portion is L*2t.

The brightness which the human being feels within a unit time period is given by an area value of a graph drawn on the axes of the brightness and the light emitting period. Accordingly, the human being feels that two lights illustrated in FIG. 16 have an equal brightness. In particular, the human being feels that light whose light emitting period is t seconds and whose brightness is 2L (indicated by vertical lines) and light whose light emitting period is 2t seconds and whose brightness is L (indicated by horizontal lines) have an equal brightness.

Meanwhile, the display performance of an organic EL device or some other display device of the self-luminous type is deteriorated by the injected charge amount, heat generation and so forth. In other words, the luminance of emitted light drops. However, experimental data have been obtained that, if the brightness is equal, then the device life is longer where the light emitting period is increased than where the peak luminance is raised.

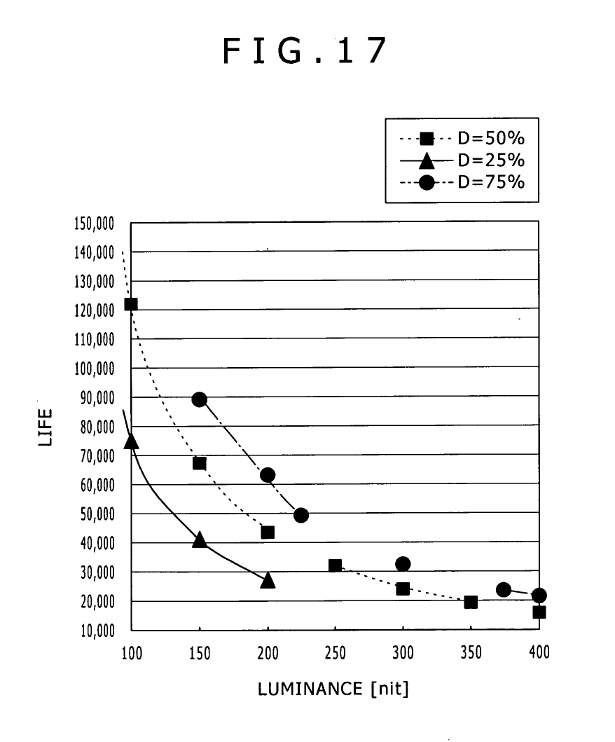

FIG. 17 illustrates experimental data. Here, a characteristic curve obtained by plotting triangular marks represents experimental data where the duty ratio is 25%. Meanwhile, another characteristic curve obtained by plotting square marks represents experimental data where the duty ratio is 50% and round marks represents experimental data where the duty ratio is 75%. As can be recognized from the case wherein the luminance is, for example, 200 [nit], the life increases as the light emitting period increases.

Accordingly, it is preferable to increase the light emitting period as long as possible in order to elongate the device life. However, if the light emitting period is increased uniformly, then a phenomenon called “moving picture blurring” appears and drops the quality of moving pictures.

Therefore, in the present drive circuit, a technique of changing over driving conditions depending upon whether the display object is of the moving picture type or of the still picture type. In particular, where the display object is image data of the still picture type, driving conditions that the light emitting period is 2t seconds and that the brightness is L are selected. However, where the display object is image data of the moving picture type, driving conditions that the light emitting period is t seconds and that the brightness is 2L are selected.

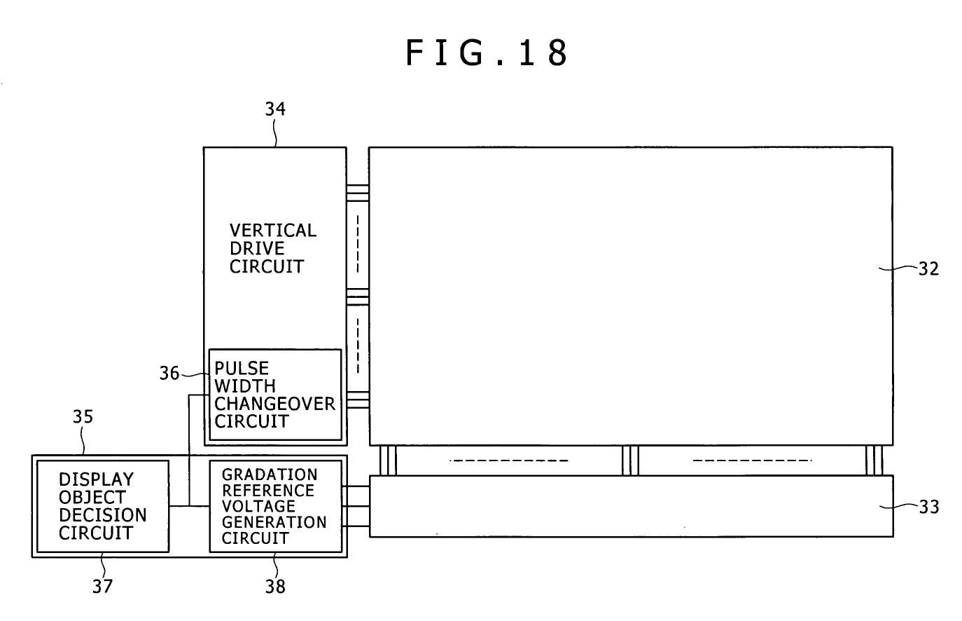

FIG. 18 shows a configuration example of the drive circuit just described. It is to be noted that FIG. 18 shows not only the drive circuit but also a display region 32 which is a driving object of the drive circuit. The drive circuit includes a horizontal drive circuit 33, a vertical drive circuit 34 and a driving condition changeover circuit 35 for controlling the driving conditions for them as principal components thereof.

To the horizontal drive circuit 33 among the components, the configuration examples described hereinabove are applied. In particular, a horizontal drive circuit including sample hold circuits 23 is used. Where such a sample hold circuit 23 as described above is used, an output which is stable also upon changeover of the gradation reference voltage (maximum reference voltage) to increase to twice or to decrease to one half can be anticipated.

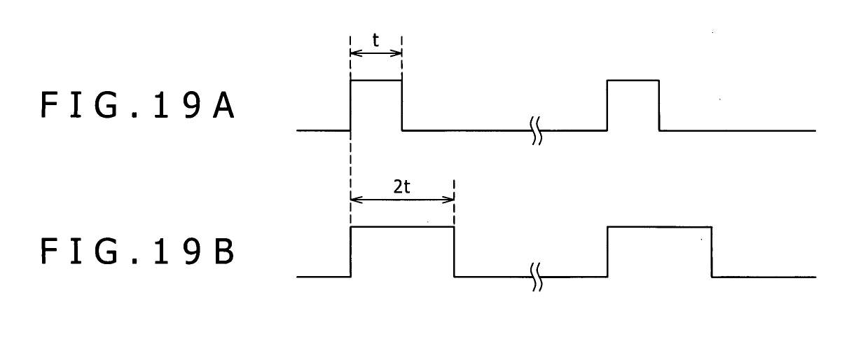

Further, the vertical drive circuit 34 additionally incorporates a pulse width changeover circuit 36 in addition to a well-known circuit configuration. The pulse width changeover circuit 36 implements a function of controlling changeover of the light emitting period. In particular, the pulse width changeover circuit 36 implements a function of selecting one of two different scanning line selection pulses (also called “scanning pulses”) illustrated in FIGS. 19A and 19B.

Incidentally, FIG. 19A illustrates a scanning line selection pulse whose light emitting period is t. Meanwhile, FIG. 19B illustrates another scanning line selection pulse whose light emitting period is 2t. A period within which the scanning line selection pulse has a logic “H” level corresponds to a period within which the active element corresponding to each sub pixel is controlled to an on state. In other words, a light emitting substance or a light emitting element corresponding to the active element emits light for a period of time corresponding to the pulse width.

Naturally, the brightness upon lighting is a brightness according to the gradation reference voltage (maximum reference voltage) applied from the horizontal drive circuit 33. In particular, where the light emitting period is t, the brightness is 2L. On the other hand, where the light emitting period is 2t, the brightness is L.

It is to be noted that the changeover action of the pulse width changeover circuit 36 is controlled by the driving condition changeover circuit 35.

In particular, if it is decided that the display object is image data of the still picture type, then the pulse width changeover circuit 36 selectively outputs a scanning line selection pulse (FIG. 19B) whose light emitting period is 2t. On the other hand, if it is decided that the display object is image data of the moving picture type, then the pulse width changeover circuit 36 selectively outputs another scanning line selection pulse (FIG. 19A) whose light emitting period is t.

Now, a circuit configuration of the driving condition changeover circuit 35 is described. The driving condition changeover circuit 35 includes a display object decision circuit 37 and a gradation reference voltage generation circuit 38. Various techniques are available for a method of deciding a display object by the display object decision circuit 37.

For example, a technique is available which decides whether image data are those of the still picture type or of the moving picture type depending upon the difference of the input terminal to which the image data is inputted. In this instance, if the image data is inputted from an antenna input terminal or a video input terminal, then the display object decision circuit 37 decides that the image data is of the moving picture type. On the other hand, if the image data is inputted from a computer input terminal, then the display object decision circuit 37 decides that the image data is of the still picture type.

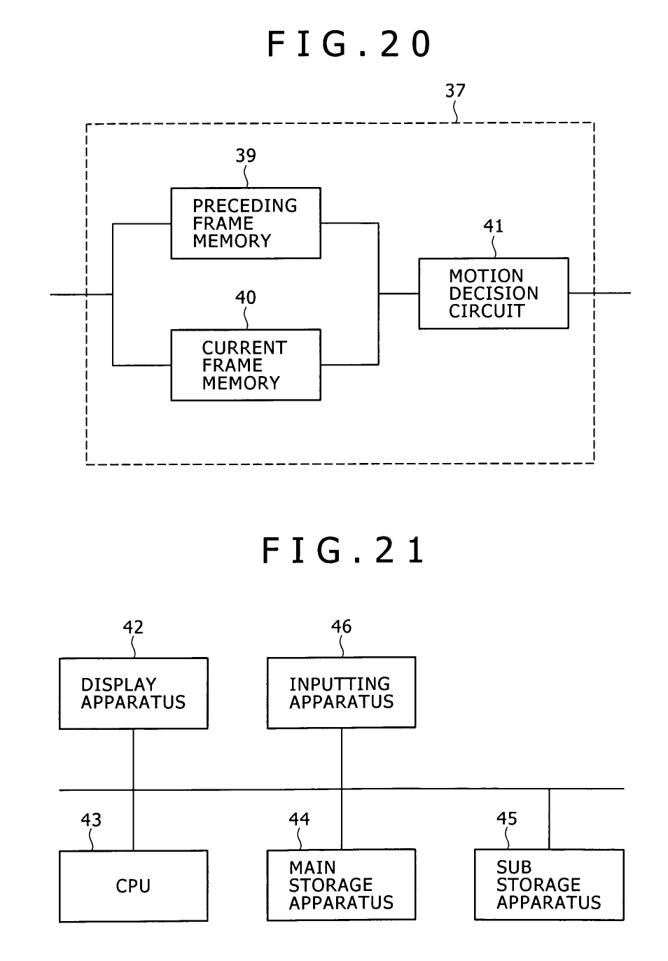

Also another technique is available wherein a preceding screen and a current screen are compared with each other and a decision is made based on whether the current screen exhibits a large amount of motion or a small amount of motion. A circuit example of the display object decision circuit 37 of the type just described is shown in FIG. 20. In this instance, the display object decision circuit 37 includes a preceding frame memory 39, a current frame memory 40, and a motion decision circuit 41.

The preceding frame memory 39 is a memory for storing a preceding frame, and the current frame memory 40 is a memory for storing a current frame. The motion decision circuit 41 compares the two frames to make a decision of whether the current frame is an image (frame or field) of the moving picture type or an image (frame or field) of the still picture type.

For example, there is a technique wherein, if the number of pixels or the number of image blocks which exhibit coincidence between the two frames is equal to greater than one half, then it is decided that the image data is of the still picture, but conversely if the number is smaller than one half, then it is decided that the image data is of the moving picture type. Also there is a method wherein such a decision as described above is performed, for example, with regard to a portion of a screen in the proximity of the center which is easily perceived by the visual sense.

It is to be noted that the threshold value to be used for the decision is not necessarily limited to ½ the sample number as described but may be greater or smaller than ½. In other words, the threshold value should be set so that the decision result and the display result exhibit good coincidence.

In addition, also a method wherein inputting of image data of the moving picture type is decided where the average value of moving vectors over the overall screen is equal to or higher than a threshold value and another method wherein inputting of image data of the moving picture type is decided where the number of motion vectors of a magnitude equal to or greater than a fixed level exceeds a threshold value are available. Also in those methods, the threshold value should be set so that the decision result and the display result exhibit good coincidence.

By adoption of such decision techniques as described above, it is possible to change over driving conditions between a scene which includes much motion and another scene which includes little motion even in the same program. Anyway, a decision result by the display object decision circuit 37 is provided to the pulse width changeover circuit 36 and the gradation reference voltage generation circuit 38 described hereinabove. It is to be noted that the decision process is executed in a unit of one screen (frame or field).

The gradation reference voltage generation circuit 38 generates one of two kinds of gradation reference voltages including a gradation reference voltage (analog) and another gradation reference voltage (digital) based on the decision result of the display object decision circuit 37.

In particular, if it is decided that image data of the moving picture type is inputted, then the gradation reference voltage generation circuit 38 generates a gradation reference voltage or gradation reference voltage data corresponding to light whose brightness is 2L. On the other hand, if it is decided that image data of the still picture type is inputted, then the gradation reference voltage generation circuit 38 generates a gradation reference voltage or gradation reference voltage data corresponding to light whose brightness is L.

It is to be noted that, while the configuration example described above controls changeover of a combination of a gradation reference voltage and a light emitting period as a choice between two choices, it is otherwise possible to select one of a plurality of (three or more) combinations which exhibit an equal product between a gradation voltage corresponding to the brightness which the human being feels within a unit period of time and the light emitting period per one scanning line.

(g-2) Effects Obtained by the Configuration Example 7

In the case of the present configuration example 7, elongation of the life of a display device can be implemented without changing the brightness perceived by the human being. Further, since the gradation reference voltage and the light emitting period are controlled switchably depending upon whether input image data is of the moving picture type or the still picture type, “moving picture blurring” and deterioration of some other visual sense characteristics can be prevented.

### (3) ELECTRONIC APPARATUS

Here, a case wherein the display apparatus described above is incorporated in various electronic apparatus is described. The electronic apparatus incorporates a signal processing system (external system) for providing a gradation reference voltage or a gradation reference voltage value for a horizontal drive circuit for each color.

It is to be noted that the electronic apparatus preferably incorporates a signal processing section which processes an image signal. One of such signal processing sections is, for example, a signal conversion section which converts a composite signal into another signal of a signal format suitable for display by a display panel.

Another one of such signal processing sections as described above is a signal conversion section which converts an array of image data in response to the pixel array of color pixels on a display panel. A further one of such signal processing sections is a decoder which decodes image data encoded in a compression coded image data (for example, MPEG (Moving Picture Coding Experts Group) format.

It is to be noted that any of such signal processing sections as described above can be implemented as one of functions of software executed by electronic apparatus which incorporate a computer. FIG. 21 shows an example of an internal configuration of an electronic apparatus which implements such a function as just described.

In the case of FIG. 21, the electronic apparatus includes a display apparatus 42, a central processing unit (CPU) 43, a main storage apparatus 44, a sub storage apparatus 45 and an inputting apparatus 46. Naturally, a display apparatus which incorporates any of the drive circuits described hereinabove is used for the display apparatus 42.

It is to be noted that, while FIG. 21 indicates that the display apparatus 42 is incorporated in the electronic apparatus, the display apparatus 42 may be externally connected as an independent apparatus.

Incidentally, the central processing unit 43 is used for control of the computer and fetching and execution of commands. The main storage apparatus 44 is used for temporary storage of a program which describes a processing procedure and data. The sub storage apparatus 45 is used for storage of a program and data.

As the storage apparatus, for example, a hard disk apparatus or some other drive apparatus for a magnetic storage medium is used. Or, for example, a drive apparatus for a compact disk or some other optical recording medium is used. Meanwhile, the inputting apparatus 46 is used to input an instruction or data to the computer. For the inputting apparatus 46, for example, a mouse, a keyboard or some other pointing device is used.

It is to be noted that the electronic apparatus preferably incorporates a communication apparatus as occasion demands. The communication channel may be a wire channel or a radio channel. Further, the communication apparatus preferably incorporates a network function. To the electronic apparatus, for example, a portable telephone set, a personal digital assistant, a computer integrated with a display, a vehicle-carried navigation terminal, a vending machine, an automatic ticket gate and so forth can be applied.

### INDUSTRIAL APPLICABILITY

According to an aspect of the present invention, light emission characteristics for individual colors can be adjusted to an appropriate relationship. According to another aspect of the present invention, the digital/analog conversion characteristic of a D/A conversion circuit can be stabilized when compared with a case wherein setting and supply of a gradation reference voltage are repeated also within a light emitting period. Consequently, further enhancement and optimization of the display quality can be implemented.

1. A display panel wherein a display region wherein sub pixels as minimum display units are arranged in a matrix and a drive circuit region configured to drive active devices corresponding to the sub pixels are formed on a same substrate,
the drive circuit region including:
a group of digital/analog conversion circuits configured to convert signal line data corresponding to the sub pixels individually into analog values;
wiring line patterns configured to apply gradation reference voltages to the group of digital/analog conversion circuits for individually corresponding colors; and
sample hold circuits configured to sample hold the gradation reference voltages corresponding to the individual colors within a period of time within a non-light emitting period of said display region and apply the gradation reference voltages to said corresponding wiring line patterns within a light emitting period of said display region.

2. A semiconductor integrated circuit having a built-in drive circuit configured to drive a display panel in which sub pixels as minimum display units are arranged in a matrix,
the drive circuit including:
a group of digital/analog conversion circuits configured to convert signal line data corresponding to the sub pixels individually into analog values;
wiring line patterns configured to apply gradation reference voltages to the group of digital/analog conversion circuits for individually corresponding colors; and
sample hold circuits configured to sample hold the gradation reference voltages corresponding to the individual colors within a period of time within a non-light emitting period of said display region and apply the gradation reference voltages to said corresponding wiring line patterns within a light emitting period of said display region.

3. The display panel according to claim 1, wherein the gradation reference voltages are a maximum reference voltage value for said digital/analog conversion circuits.

4. The semiconductor integrated circuit according to claim 2, wherein the gradation reference voltages are a maximum reference voltage value for said digital/analog conversion circuits.

5. The display panel according to claim 1, wherein the gradation reference voltages are one or a plurality of intermediate reference voltage values for said digital/analog conversion circuits.

6. The semiconductor integrated circuit according to claim 2, wherein the gradation reference voltages are one or a plurality of intermediate reference voltage values for said digital/analog conversion circuits.

7. The display panel according to claim 1, further comprising:
a serial/parallel conversion circuit configured to convert a gradation reference voltage value corresponding to each of the colors inputted as serial data into parallel data; and
a digital/analog conversion circuit for a gradation reference voltage configured to convert the parallel data corresponding to each of the colors into an analog value and apply the analog value to a corresponding one of said sample hold circuits.

8. The semiconductor integrated circuit according to claim 2, further comprising:
a serial/parallel conversion circuit configured to convert a gradation reference voltage corresponding to each of the colors inputted as serial data into parallel data; and
a digital/analog conversion circuit for a gradation reference voltage configured to convert the parallel data corresponding to each of the colors into an analog value and apply the analog value to a corresponding one of said sample hold circuits.

9. The display panel according to claim 1, further comprising:
a digital/analog conversion circuit for a gradation reference voltage configured to convert the gradation reference voltage values corresponding to the colors inputted in a time division multiplexed form into analog values; and
a changeover circuit configured to output the gradation reference voltages for the colors time-divisionally outputted from said digital/analog conversion circuit to corresponding ones of said sample hold circuits.

10. The semiconductor integrated circuit according to claim 2, further comprising:
a digital/analog conversion circuit for a gradation reference voltage configured to convert the gradation reference voltage values corresponding to the colors inputted in a time division multiplexed form into analog values; and
a changeover circuit configured to output the gradation reference voltages for the colors time-divisionally outputted from said digital/analog conversion circuit to corresponding ones of said sample hold circuits.

11. The display panel according to claim 1, further comprising:
a serial/parallel conversion circuit configured to convert serial data of the gradation reference voltage values corresponding to the colors inputted in a time division multiplexed form into parallel data;
a digital/analog conversion circuit for a gradation reference voltage configured to convert the parallel data corresponding to the colors individually into analog values; and
a changeover circuit configured to output the gradation reference voltages for the colors outputted time-divisionally from said digital/analog conversion circuit to corresponding ones of said sample hold circuits.

12. The semiconductor integrated circuit according to claim 2, further comprising:
a serial/parallel conversion circuit configured to convert serial data of the gradation reference voltage values corresponding to the colors inputted in a time division multiplexed form into parallel data;
a digital/analog conversion circuit for a gradation reference voltage configured to convert the parallel data corresponding to the colors individually into analog values; and
a changeover circuit configured to output the gradation reference voltages for the colors outputted time-divisionally from said digital/analog conversion circuit to corresponding ones of said sample hold circuits.

13. The display panel according to claim 1, further comprising:
a gradation reference voltage generation circuit configured to generate a gradation voltage corresponding to any one of a plurality of combinations which provide an equal product between a gradation voltage corresponding to a brightness which the human being feels within a unit period of time and a light emitting period per one scanning line; and
a light emitting period control circuit configured to control the light emitting period per one scanning line to a light emitting period paired with the gradation voltage generated by said gradation reference voltage generation circuit.

14. The semiconductor integrated circuit according to claim 2, further comprising:
a gradation reference voltage generation circuit configured to generate a gradation voltage corresponding to any one of a plurality of combinations which provide an equal product between a gradation voltage corresponding to a brightness which the human being feels within a unit period of time and a light emitting period per one scanning line; and
a light emitting period control circuit configured to control the light emitting period per one scanning line to a light emitting period paired with the gradation voltage generated by said gradation reference voltage generation circuit.

15. The display panel according to claim 1, further comprising:
a decision circuit configured to decide whether a display object is image data of the still picture type or image data of the moving picture type;
a gradation reference voltage generation circuit configured to output a gradation reference voltage corresponding to a brightness L which the human being feels within a unit period of time when it is decided that the display object is image data of the still picture type but output a gradation reference voltage corresponding to another brightness 2L which the human being feels within a unit period of time when it is decided that the display object is image data of the moving picture type; and
a light emitting period control circuit configured to control the light emitting period per one scanning line to 2t when it is decided that the display object is image data of the still picture type but control the light emitting period per one scanning line to t when it is decided that the display object is image data of the moving picture type.

16. The semiconductor integrated circuit according to claim 2, further comprising:
a decision circuit configured to decide whether a display object is image data of the still picture type or image data of the moving picture type;
a gradation reference voltage generation circuit configured to output a gradation reference voltage corresponding to a brightness L which the human being feels within a unit period of time when it is decided that the display object is image data of the still picture type but output a gradation reference voltage corresponding to another brightness 2L which the human being feels within a unit period of time when it is decided that the display object is image data of the moving picture type; and
a light emitting period control circuit configured to control the light emitting period per one scanning line to 2t when it is decided that the display object is image data of the still picture type but control the light emitting period per one scanning line to t when it is decided that the display object is image data of the moving picture type.

17. A displaying apparatus, comprising:
a display panel according to claim 1.

18. A displaying apparatus, comprising:
a display panel wherein sub pixels as minimum display units are arranged in a matrix; and
a semiconductor integrated circuit according to claim 2.

19. An electronic apparatus, comprising:
a display panel according to claim 1; and
a signal processing section configured to apply a gradation reference voltage value to said display panel.

20. An electronic apparatus, comprising:
a semiconductor integrated circuit according to claim 2; and
a signal processing section configured to apply a gradation reference voltage value to said semiconductor integrated circuit.
